(19) United States
(12) Patent Application Publication
(10) Pub. No.: US 2026/0121063 A1
(43) Pub. Date: Apr. 30, 2026

(54) LITHIUM-SULFUR BATTERY POSITIVE ELECTRODE, LITHIUM-SULFUR BATTERY, AND CHARGING/DISCHARGING METHOD FOR THE SAME

(71) Applicant: ABRI Co., Ltd., Tokyo (JP)

(72) Inventors: Koshin Takemoto, Tokyo (JP); Jungo Wakasugi, Tokyo (JP); Masaaki Kubota, Tokyo (JP); Hidetoshi Abe, Tokyo (JP)

(73) Assignee: ABRI Co., Ltd., Tokyo (JP)

(21) Appl. No.: 19/002,394

(22) Filed: Dec. 26, 2024

Related U.S. Application Data
(63) Continuation of application No. PCT/JP2023/012139, filed on Mar. 27, 2023.

(30) Foreign Application Priority Data
Apr. 26, 2022 (JP) 2022-072519

(51) Int. Cl. H01M 4/62; H01M 4/36; H01M 4/485; H01M 4/58; H01M 10/052; H01M 10/0569; H01M 10/44

(52) U.S. Cl. CPC H01M 4/628; H01M 4/366; H01M 4/485; H01M 4/5815; H01M 4/625; H01M 10/052; H01M 10/0569; H01M 10/44; H01M 2300/0037

(57) ABSTRACT

One embodiment of the present application provides a lithium-sulfur battery positive electrode including a positive electrode current collector and a sulfur layer deposited on a surface of the positive electrode current collector, wherein the sulfur layer contains sulfur and/or a sulfur compound which is a main positive electrode active material, a lithium-containing oxide, and a nitrogen-containing organic compound, and the nitrogen-containing organic compound is a nitrogen-containing heterocyclic compound.

### CROSS-REFERENCE TO RELATED APPLICATIONS

This application is a Continuation application of PCT Application No. PCT/JP2023/012139, filed Mar. 27, 2023 and based upon and claiming the benefit of priority from prior Japanese Patent Application No. 2022-072519, filed Apr. 26, 2022, the entire contents of all of which are incorporated herein by reference.

### BACKGROUND OF THE INVENTION

### 1. Field of the Invention

The present invention relates generally to a lithium-sulfur battery positive electrode, a lithium-sulfur battery, and a charging/discharging method for the same.

### 2. Description of the Related Art

In recent years, the use of nonaqueous electrolyte secondary batteries such as lithium ion secondary batteries has expanded significantly as power sources for portable devices such as mobile phones, power tools, electric vehicles, and the like. Nonaqueous electrolyte secondary batteries are required to have even higher energy density and longer life as these power sources.

Currently, lithium-sulfur batteries have been focused as one of the next generation batteries due to their higher energy density. Such a lithium-sulfur battery performs charging and discharging by moving lithium ions between a positive electrode and a negative electrode. The positive electrode comprises, for example, a sulfur layer which contains a positive electrode active material formed of sulfur and/or a sulfur compound, a conductive additive, and a binder, and a positive electrode current collector which supports the sulfur layer. The negative electrode comprises, for example, lithium metal and a negative electrode current collector supporting the lithium metal. A separator is interposed between the positive electrode and the negative electrode. An electrode plate group including a positive electrode, a negative electrode, and a separator is housed in a battery container together with a nonaqueous electrolyte. As the nonaqueous electrolyte, a nonaqueous electrolyte solution in which an electrolyte such as a lithium salt is dissolved in a nonaqueous solvent is generally used.

At present, however, lithium-sulfur batteries have the problem that they cannot achieve sufficient charge-discharge cycle performance and reach the end of their life early. One specific reason among the reasons is a phenomenon referred to as the redox shuttle effect. In such a phenomenon, lithium polysulfide (Li₂S₈, Li₂S₆, and the like), which is a reaction intermediate product on the positive electrode side, dissolves and diffuses into the electrolyte solution due to repetition of charging and discharging. The diffused lithium polysulfide electrophores during charging and is reduced on the negative electrode, further diffused, and oxidized on the positive electrode side. This electrochemical reaction proceeds until the lithium polysulfide becomes Li₂S, causing self-discharge of the battery. In order to improve the charge-discharge cycle performance of lithium-sulfur batteries, it is necessary to suppress the redox shuttle effect.

In addition, lithium-sulfur batteries have the problem that sufficient discharge rate performance cannot be obtained and the discharge capacity is particularly small when a high current is applied. One of the reasons is that positive electrode active materials formed of sulfur and/or sulfur compounds have low ionic conductivity and low electronic conductivity. In addition, in order to obtain a high energy density, it is necessary to coat (or support) a large amount of positive electrode slurry containing a positive electrode active material on the positive electrode current collector but, in such a case, the discharge capacity per positive electrode weight further decreases since the internal resistance in the sulfur layer increases.

In order to solve these problems, various studies have proceeded to improve the battery performances of lithium-sulfur batteries.

In Non-Patent Literature 1 (Zhi Chang et al., New J. Chem, 2016, 40, p. 7680 to 7686), a method of wrapping a sulfur/carbon mixture material with a nitrogen-containing organic compound, more specifically, cyclic polyacrylonitrile have been reviewed. In Non-Patent Literature 2 (Huadong Yuan et al., Energy Storage Materials. 2018, 10, p. 1 to 9), a sulfur layer containing both sulfur and graphene in which some of carbon atoms are replaced with nitrogen atoms (nitrogen-doped graphene) have been reviewed. Cyclic polyacrylonitrile and nitrogen-doped graphene have a role of adsorbing polysulfide and suppressing its elution. In the lithium-sulfur batteries disclosed in Non-Patent Literature 1 and 2, a manufacturing process of wrapping a mixture material with a nitrogen-containing organic compound and a manufacturing process of nitrogen-doped graphene are extremely complicated and expensive.

In Non-Patent Literature 3 (Jun Ming et al., ACS Nano, 2016, Vol. 10, p. 6037 to 6044), forming a graphite/Li₄Ti₅O₁₂ double layer on a surface of a sulfur layer of a lithium-sulfur battery has been reviewed. This double layer has a role of trapping polysulfide dissolved in the electrolyte solution therein and suppressing its diffusion to the surface of the negative electrode. As a result, the redox shuttle effect can be suppressed and the charge/discharge cycle performance can be improved.

### BRIEF SUMMARY OF THE INVENTION

In Non-Patent Literature 1 and 2, however, there have been problems that the ionic conductivity within the sulfur layer is insufficient, the internal resistance of the battery is high, and the discharge capacity is decreased. In addition, in the lithium-sulfur battery disclosed in Non-Patent Literature 3, the presence of the double layer prevents the supply of lithium ions from the nonaqueous electrolyte solution, the ionic conductivity in the sulfur layer is lowered, and the internal resistance of the battery is increased.

For this reason, in these batteries, it has been required to lower the internal resistance of the sulfur layer to suppress the decrease in discharge capacity, and to further improve the charge/discharge cycle performance.

The present invention provides a lithium-sulfur battery positive electrode, a lithium-sulfur battery, and a charging/discharging method for the same, capable of solving the above problems and simultaneously achieving the improvement in discharge rate performance and the enhancement in charge/discharge cycle performance.

In order to solve the above problems, according to one embodiment, there is provided a lithium-sulfur battery positive electrode comprising a positive electrode current collector and a sulfur layer deposited on the surface of the positive electrode current collector, the sulfur layer contains sulfur and/or a sulfur compound as a main positive electrode active material, and a lithium-containing oxide and a nitrogen-containing organic compound, and the nitrogen-containing organic compound is a nitrogen-containing heterocyclic compound.

In order to solve the above problems, according to another embodiment, there is provided a lithium-sulfur battery comprising the above-described lithium-sulfur battery positive electrode, a negative electrode capable of storing and releasing lithium ions, and a separator impregnated with a nonaqueous electrolyte solution.

In order to solve the above problems, according to another embodiment, there is provided a lithium-sulfur battery charging/discharging method comprising discharging is performed by setting a lower limit of a discharge voltage to 1.0 V (vs.Li/Li⁺) or more and 1.5 V (vs. Li/Li⁺) or less.

According to the present invention, a lithium-sulfur battery positive electrode, a lithium-sulfur battery, and a charging/discharging method for the same capable of simultaneously achieving the improvement in discharge rate performance and the enhancement in charge/discharge cycle performance can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing an example of a lithium-sulfur battery according to a first embodiment.

FIG. 2 is a cross-sectional view showing an example of a lithium-sulfur battery according to a second embodiment.

FIG. 3 is a graph showing a charge/discharge curve of Example 20.

### DETAILED DESCRIPTION OF THE INVENTION

A lithium-sulfur battery positive electrode according to embodiments will be described below in detail.

### <Positive Electrode>

The positive electrode comprises a positive electrode current collector and a sulfur layer deposited on the surface of the positive electrode current collector. The sulfur layer contains sulfur and/or a sulfur compound as the main positive electrode active material, a lithium-containing oxide, and a nitrogen-containing organic compound. The nitrogen-containing organic compound is a nitrogen-containing heterocyclic compound.

According to the lithium-sulfur battery positive electrode according to such an embodiment, it is possible to simultaneously achieve the improvement in discharge rate performance and the enhancement in charge/discharge cycle performance.

Since the sulfur layer contains both a lithium-containing oxide and a nitrogen-containing organic compound and since the nitrogen-containing organic compound is a nitrogen-containing heterocyclic compound, lithium polysulfide, which is a reaction intermediate product on the positive electrode side and which is generated by repeating charging and discharging, can be efficiently captured inside the sulfur layer, suppressing the redox shuttle effect and improving the charge/discharge cycle performance of the battery. Both the lithium-containing oxide and the nitrogen-containing organic compound have a high effect of adsorbing lithium polysulfide, but the sufficient effect could not be obtained when only one of them was contained. The present inventors have discovered that by containing both of these in the sulfur layer, the above effects can be significantly obtained by their synergistic effect.

In addition, since it is possible to improve the ionic conductivity within the sulfur layer and reduce the resistance (charge transfer resistance) at the interface between the positive electrode and the electrolyte solution, by containing the lithium-containing oxide in the sulfur layer, the internal resistance can be lowered. Thus, the internal resistance of the battery in which the positive electrode is incorporated can be reduced, and the discharge capacity can be particularly improved when a high current is applied.

Furthermore, by containing the nitrogen-containing organic compound, the wettability of the electrolyte solution to the sulfur layer is improved and the ionic conductivity within the sulfur layer is improved.

In several embodiments, the positive electrode comprises a positive electrode current collector and a sulfur layer formed on one or both surfaces of the positive electrode current collector.

The positive electrode current collector is not particularly limited, and any publicly known or commercially available positive electrode current collector can be used. As the positive electrode current collector, for example, a rolled foil formed of aluminum, nickel, copper, or an alloy thereof, or stainless steel, an electrolyte foil, a metal mesh, a porous metal, an expanded grid, a punched metal, and the like can be used. For the positive electrode current collector, carbon coated aluminum foil is desirably used to improve the electrical conductivity sulfur layer and the adhesion between the sulfur layer and the positive electrode current collector.

As described above, the sulfur layer contains sulfur and/or a sulfur compound, a lithium-containing oxide, and a nitrogen-containing organic compound. The sulfur layer may further contain a binder and/or a conductive additive.

The sulfur and/or sulfur compound is the main positive electrode active material capable of storing and releasing lithium ions. Examples of the sulfur and/or sulfur compound include crystalline sulfur, granular sulfur, colloidal sulfur, lithium sulfide, lithium polysulfide (Li₂Sₓ, x=4 to 8), organic sulfur compounds or carbon-sulfur polymers ((C₂Sₓ)ₙ, x=2.5 to 50, n≥2), and the like. The sulfur and/or sulfur compound may be a single substance or a mixture of a plurality of substances, and their combination and ratio thereof can be arbitrarily selected depending on the purpose. The sulfur and/or sulfur compound is desirably granular sulfur, more desirably colloidal sulfur.

The conductive additive is not particularly limited as long as it is a material that can improve the electronic conductivity of the sulfur layer, and any known conductive additive can be used. Examples of the conductive additive include carbon black such as ketjen black and acetylene black, and a carbon-based conductive additive such as carbon nanotubes, graphene, porous carbon, artificial graphite, natural graphite, and activated carbon. By containing the conductive additive, high rate performance and charge/discharge cycle performance can be improved, and polarization can be reduced. As the conductive additive, a conductive additive having a specific surface area of 500 to 2500 m2g⁻¹ is desirable since these effects are high. The conductive additive may be a single substance or a mixture of a plurality of substances, and its combination and ratio thereof can be arbitrarily selected depending on the purpose. Porous carbon is desirable among the substances.

It is desirable that part or all of the sulfur and/or sulfur compound be composited with part or all of the carbon-based conductive additive such as carbon black to be mixed as a sulfur-carbon composite material. Examples of a method of preparing the sulfur-carbon composite material include melt impregnation, electrolyte deposition, vapor deposition, immersion, and mechanical mixing, and the like, and the melt impregnation is desirable. By forming the sulfur-carbon composite material, the electronic conductivity of the sulfur and/or sulfur compound can be improved. The sulfur-carbon composite material may be, for example, an S/KB composite material prepared by mixing sulfur(S) and ketjen black (KB) at a weight ratio of 70:30 and heat-treating the mixture for 12 hours. In addition, the sulfur and/or sulfur compound and the sulfur-carbon composite material may be used in combination. Furthermore, the composited carbon-based conductive additive may be the same as the conductive additive.

The binder is not particularly limited as long as it is a material that binds the materials contained in the sulfur layer to each other, and any publicly known or commercially available binder can be used. Examples of the binder include polyvinylidene fluoride (PVDF), polyvinylidene fluoride-propylene hexafluoride copolymer (PVDF-HFP), polyacrylic acid (PAA), polyliacrylic acid lithium (PAALi), polytetrafluoroethylene (PTFE), polyvinylpyrrolidone (PVP), polyvinyl chloride (PVC), polyethylene (PE), polypropylene (PP), ethylene-propylene copolymer, styrene-butadiene rubber (SBR), polyvinyl alcohol (PVA), polyethylene oxide (PEO), polyethylene glycol (PEG), carboxymethyl cellulose (CMC), polyacrylonitrile (PAN), polyimide (PI), acrylic resin, and the like. The binder may be a single substance or a mixture of a plurality of substances, and its combination and ratio thereof can be arbitrarily selected depending on the purpose. The binder is desirably PVDF, SBR, and CMC.

The lithium-containing oxide adsorbs lithium polysulfide and supplies lithium ions into the sulfur layer, improving the ionic conductivity in the sulfur layer and further lowering the resistance (charge transfer resistance) at the interface between the positive electrode and the electrolyte solution. Publicly known oxides can be used as the lithium-containing oxides, and its examples include lithium-titanium composite oxides such as Li₄Ti₅O₁₂, LiTiO₄, Li₂Ti₃O₇, Li_{0.35}La_{0.55}TiO₃, Li_{1+x+y}Alₓ (Ti, Ge)₂₋ₓSi_{y}P_{3-y}O₁₂ (0≤x≤2, 0≤y≤3), and LiCoO₂, LiMn₂O₄, LiNiO₂, LiNiCoMnO₂, LiNi_{0.5}Mn_{0.5}O₂, LiMPO₄ (M=transition metal such as Mn, Fe, Co, or Ni), LiNi_{0.8}Co_{0.15}Al_{0.05}O₂, LiMnₓFe₁₋ₓPO₄ (0<x<1), LiNi_{1-x-y}CoₓMn_{y}O₂ (0<x, y, z<1), and Li₇La₃Zr₂O₁₂. The lithium-containing oxide may be a single substance or a mixture of a plurality of substances, and their combination and ratio thereof can be arbitrarily selected depending on the purpose.

The lithium-containing oxide has high adsorption properties for lithium polysulfide, can be expected to have a high effect of trapping lithium polysulfide in the sulfur layer, and has a high lithium ion conductivity.

The lithium-containing oxide in the sulfur layer is desirably a lithium-titanium composite oxide, more desirably, Li₄Ti₅O₁₂. The lithium-titanium composite oxide can efficiently trap lithium polysulfide into the inner side, which is a reaction intermediate product on the positive electrode side through repeated charging and discharging, suppressing the redox shuttle effect and improving the charge/discharge cycle performance of the battery. By using the lithium-titanium composite oxide as the lithium-containing oxide, the charge/discharge cycle performance of the battery incorporating the positive electrode can be further improved.

The lithium-containing oxide is desirably a compound which charges and discharges within a potential range of higher than 1.0 V (vs. Li/Li⁺) and less than 3.0 V (vs. Li/Li⁺). Examples of such compounds include lithium-titanium composite oxides, and their specific examples include Li₄Ti₅O₁₂, LiTiO₄, Li₂Ti₃O₇ and the like. With such a compound, the lithium-containing oxide can function as a sub-positive electrode active material capable of storing and releasing lithium. This is because the sulfur and/or sulfur compounds, which are the main positive electrode active materials, are also charged and discharged within the potential range. As a result, the discharge capacity of the battery can be increased and the weight energy density of the battery can be improved. The potential range for charging and discharging is more desirably higher than 1.2 V and less than 2.8 V, more desirably higher than 1.3 V and less than 2.7 V, more desirably higher than 1.4 V and less than 2.6 V, and even more desirably 1.5 V or more and less than 2.5 V.

The total content of the lithium-containing oxide and the nitrogen-containing organic compound is desirably 1% by weight or more and 20% by weight or less, based on the weight of the sulfur layer. If the total amount is less than 1% by weight, the adsorption effect of lithium polysulfide cannot be obtained, and the charge/discharge cycle performance of the battery may be deteriorated. In contrast, if the total amount exceeds 20% by weight, the content of the positive electrode active material in the sulfur layer may be relatively reduced and the weight energy density of the battery may be reduced.

The total content of the lithium-containing oxide and the nitrogen-containing organic compound is more desirably 4% to 20% by weight, more desirably 5% to 15% by weight, and even more desirably 6% to 12% by weight.

The content of the lithium-containing oxide is desirably more than 0% by weight and less than 20% by weight, based on the weight of the sulfur layer. When the sulfur layer contains the lithium-containing oxide in the above-described content, the internal resistance of the sulfur layer can be reduced and, particularly, the high rate performance can be improved, by its high ionic conductivity. This is because the lithium-containing oxide conducts lithium ions into the sulfur layer during repetition of charging and discharging. Thus, the internal resistance of the battery in which the positive electrode is incorporated can be reduced and, particularly, the high rate performance can be improved.

The content of the lithium-containing oxide is more desirably 5% by weight or more and 10% by weight or less, based on the weight of the sulfur layer.

The nitrogen-containing organic compound is a nitrogen-containing heterocyclic compound, and is a compound containing a nitrogen-containing heterocyclic skeleton. The nitrogen-containing organic compound adsorbs lithium polysulfide into the inner side and suppresses the redox shuttle effect. Furthermore, the wettability of the electrolyte solution to the sulfur layer is improved, and the ionic conductivity in the sulfur layer is improved. As a result of this, the discharge rate performance and cycle performance of the lithium-sulfur battery comprising the positive electrode are improved.

The nitrogen-containing heterocyclic skeleton may be, for example, a monocyclic or polycyclic skeleton containing a 4- to 6-membered aromatic heterocyclic skeleton or aliphatic heterocyclic skeleton. Examples of the nitrogen-containing heterocyclic skeleton include skeletons formed of pyridine, pyrrole, pyrimidine, carbazole, benzimidazole, and derivatives thereof.

Examples of nitrogen-containing heterocyclic compounds include cyclic polyacrylonitrile and its derivatives, poly(N-vinylcarbazole) and its derivatives, poly(benzimidazobenzophenanthroline) and its derivatives, poly(N-vinylpyridine) and its derivatives, poly(N-vinylpyrrolidone) and its derivatives, tetraphenylporphyrin and its derivatives, and the like. The structural formulas of these compounds are shown below. For example, n is a natural number from 3 to 15.

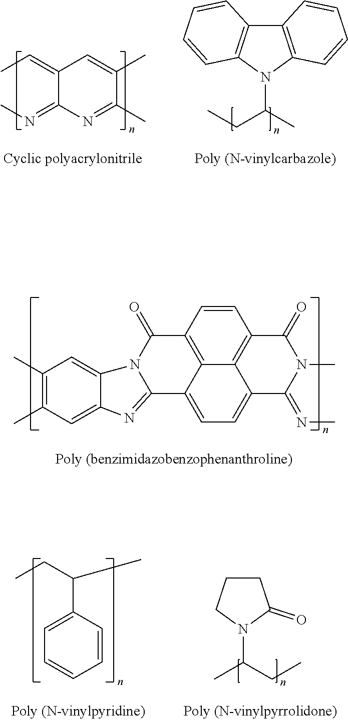

A material that is difficult to dissolve in the nonaqueous electrolyte solution is desirable as the nitrogen-containing heterocyclic compound. The nitrogen-containing heterocyclic compound is desirably a polymer containing a nitrogen-containing heterocyclic skeleton in its repeating structural unit, and examples of the polymer include the compounds listed above. The nitrogen-containing heterocyclic compound may be, for example, a polymer of monomers containing a nitrogen-containing heterocyclic skeleton. The nitrogen-containing heterocyclic compound may be a single substance or a mixture of a plurality of substances, and their combination and ratio thereof can be arbitrarily selected depending on the purpose.

The nitrogen-containing heterocyclic compound is desirably a compound containing a pyridine cyclic skeleton, and its examples include cyclic polyacrylonitrile and its derivatives, and poly(N-vinylpyridine) and its derivatives. This is because a compound containing a pyridine cyclic skeleton has a high property of adsorbing lithium polysulfide and can be expected to have a high effect of trapping it in the sulfur layer. The nitrogen-containing heterocyclic compound is, more preferably, sulfurized polyacrylonitrile.

The pyridine cyclic skeleton can be identified by, for example, X-ray photoelectron spectroscopy.

Sulfurized polyacrylonitrile is a type of cyclic polyacrylonitrile derivative, and is a cyclic polyacrylonitrile modified with sulfur. Sulfurized polyacrylonitrile may be, for example, polyacrylonitrile modified with sulfur, which can be obtained by mixing sulfur powder with polyacrylonitrile powder, and reacting sulfur vapor with polyacrylonitrile simultaneously with the ring closure reaction of polyacrylonitrile, by a method of heating in a non-oxidizing atmosphere in a state that elution of sulfur can be prevented. When used sulfurized polyacrylonitrile as a nitrogen-containing heterocyclic compound, other sulfur or sulfur compound is contained as the positive electrode active material. The estimated structural formula of sulfurized polyacrylonitrile is shown below. The sulfurized polyacrylonitrile may be a compound containing the following structure in part or in whole. For example, n is a natural number from 3 to 15.

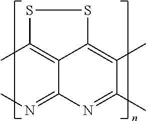

The nitrogen-containing organic compound is desirably a compound which charges and discharges within a potential range of higher than 1.0 V (vs. Li/Li⁺) and less than 3.0 V (vs. Li/Li⁺). Examples of such a compound include sulfurized polyacrylonitrile and derivatives thereof. When the nitrogen-containing organic compound is such a compound, the nitrogen-containing organic compound can function as a sub-positive electrode active material capable of storing and releasing lithium. This is because the sulfur and/or sulfur compounds, which are the main positive electrode active materials, are also charged and discharged within the potential range. As a result, the discharge capacity of the battery can be increased and the energy density of the battery can be improved. The potential range for charging and discharging is more desirably higher than 1.2 V and less than 2.8 V, more desirably higher than 1.3 V and less than 2.7 V, more desirably higher than 1.4 V and less than 2.6 V, even more desirably 1.5 V or more and less than 2.5 V.

In the sulfur layer, when the content of the lithium-containing oxide is represented by A and the content of the nitrogen-containing organic compound is represented by B, it is desirable that A≥B. When the sulfur layer contains the lithium-containing oxide in the above-described content, the internal resistance of the sulfur layer can be reduced, the polarization can be reduced, and, particularly, the high rate performance can be improved, by its high ionic conductivity. Incidentally, the content is assumed to be obtained in terms of weight.

The content ratio of the lithium-containing oxide to the nitrogen-containing organic compound (A:B) is desirably 5:5 to 9:1, more desirably 6:4 to 9:1, more desirably is 7:3 to 9:1, and even more desirably 8:2 to 9:1.

The content of the sulfur and/or sulfur compounds is desirably 50% by weight or more, more desirably 55% to 90% by weight, and even more desirably 55% to 65% by weight, based on the weight of the sulfur layer. If the content of sulfur and/or sulfur compound is less than 50% by weight, the content of the positive electrode active material in the sulfur layer is reduced, which is undesirable since the weight energy density of the battery may be lowered.

The sulfur layer desirably contains sulfur, a sulfur compound and a sulfur carbon composite material whose total amount is in the range of 60% to 90% by weight, the conductive additive whose amount is in the range of 0% to 25% by weight, the binder whose amount is in the range of 3% to 5% by weight, and the lithium-containing oxide and nitrogen-containing organic compound whose total amount is in the range of 1% to 20% by weight. More desirably, the amount of the conductive additive is 4% to 25% by weight. Incidentally, one or more of sulfur, the sulfur compound, and the sulfur-carbon composite material may be contained.

The sulfur layer desirably contains nitrogen-containing compound particles dispersed in the sulfur layer as particles separate from the positive electrode active material particles. More desirably, the sulfur layer has a structure in which particles of a sulfur-carbon composite material obtained by compositing a positive electrode active material and a carbon-based conductive additive, lithium-containing oxide particles, and nitrogen-containing compound particles are mutually dispersed and bound together in the sulfur layer as separate particles. In such a positive electrode, the sulfur layer can be prepared by a simple process of dispersing these particles in a solvent to prepare a sulfur layer slurry, applying the sulfur layer slurry to the positive electrode current collector, and then drying the slurry. Such a positive electrode can achieve particularly high rate performance and the enhancement in the charge/discharge cycle performance at the same time.

The thickness of the sulfur layer may be any general thickness, for example, 20 μm to 300 μm as the value of the electrode taken from a battery with 100% SOC.

In several embodiments, the positive electrode further comprises a ceramic layer laminated on the surface of the sulfur layer, in addition to the positive electrode current collector and the sulfur layer.

Since the ceramic layer is laminated on the surface of the sulfur layer, lithium polysulfide, which is a reaction intermediate product on the positive electrode side and which is generated by repeating charging and discharging, can be efficiently captured inside the ceramic layer, the redox shuttle effect can be suppressed, and the charge/discharge cycle performance of the battery can be improved. If there is another layer such as a graphite layer between the sulfur layer and the ceramic layer, the supply of lithium ions from the nonaqueous electrolyte solution is hindered, and the ionic conductivity in the sulfur layer is lowered, which is undesirable since the internal resistance of the battery may increase.

The ceramic layer contains ceramic powder as a main component. The layer may contain a binder and a conductive additive.

The ceramic powder is a compound that can trap lithium polysulfide in itself. Examples of ceramic powder include titanium oxide, titanium nitride, or titanium-based composite oxide such as TiO₂, TiN, Li₄Ti₅O₁₂, TiNb₂O₇, LiTiO₄, Li₂Ti₃O₇, Li_{1+x+y}Alₓ(Ti,Ge)₂₋ₓSi_{y}P_{3-y}O₁₂ (0≤x≤2, 0≤y≤3), La_{0.57}Li_{0.29}TiO₃, and Li_{1+x+y}AlₓTi₂₋ₓSi_{y}P_{3-y}O₁₂ (0≤x≤1, 0≤y≤1), and Al₂O₃, LiCoO₂, LiMn₂O₄, LiNiO₂, LiNiCoMnO₂, LiNi_{0.5}Mn_{0.5}O₂, LiMPO₄ (M=transition metal such as Mn, Fe, Co, or Ni), LiNi_{0.8}Co_{0.15}Al_{0.05}O₂, Li_{0.35}La_{0.55}TiO₃, LiMnₓFe₁₋ₓPO₄ (0<x<1), LiNi_{1-x-y}CoₓMn_{y}O₂ (0<x, y, z<1), Li₇La₃Zr₂O₁₂, and the like.

The ceramic powder is desirably composed of a compound which charges and discharges within a potential range of higher than 1.0 V (vs. Li/Li⁺) and less than 3.0 V (vs. Li/Li⁺).

By using a compound which charges and discharges in the above potential range as the ceramic powder, the ceramic powder can function as a sub-positive electrode active material which can store and release lithium. This is because since sulfur and/or sulfur compounds, which are the main positive electrode active materials of the positive electrode, are generally charged and discharged within a potential range of 2.4 V to 1.8 V (vs. Li/Li⁺), the ceramic powder is also charged and discharged at the same time. As a result, the discharge capacity of the battery can be remarkably increased and the energy density of the battery can be improved.

Since the ceramic powder is formed of a compound which charges and discharges within the above-described potential range and since the ceramic layer is laminated on the surface of the sulfur layer, the sulfur compounds dissolved from the sulfur layer during discharge are captured on the ceramic powder and, furthermore, the sulfur compounds are reduced on the ceramic powder. During the reduction of the ceramic powder, the discharge can be continued until the sulfur compound is also sufficiently reduced (discharged) at the same time, the efficiency of use of sulfur can be improved, and the discharge capacity of the battery incorporating the positive electrode can be improved.

Examples of the compounds which charge and discharge within the above-described potential range include titanium oxide or titanium-based composite oxides such as TiO₂, Li₄Ti₅O₁₂, TiNb₂O₇, LiTiO₄, Li₂Ti₃O₇, La_{0.57}Li_{0.29}TiO₃, and Li_{1+x+y}AlₓTi₂₋ₓSi_{y}P_{3-y}O₁₂ (0≤x≤1, 0≤y≤1), desirably Li₄Ti₅O₁₂.

The ceramic powder is desirably formed of a compound which makes a reduction reaction at a potential lower than 1.8 V (vs. Li/Li⁺). For example, Li₄Ti₅O₁₂ is a compound which discharges at a potential of approximately 1.55 V (vs. Li/Li⁺).

The ceramic layer desirably contains a binder in order to improve binding between the ceramic powders. The binder is not particularly limited as long as it is a material which binds the materials included in the ceramic layer to each other, and any publicly known binder can be used. As the binder, for example, the same binders as those mentioned as the binders for the sulfur layer can be used.

The ceramic layer desirably contains a conductive additive in order to improve the electronic conductivity. The conductive additive is not particularly limited as long as it is a material which can improve the electronic conductivity of the ceramic layer, and any publicly known conductive agent can be used. As the conductive additive, for example, the same conductive additives as those mentioned as the conductive additives for the sulfur layer can be used.

The content of the ceramic powder is desirably 80% by weight or more and 98% by weight or less, more desirably 85% by weight or more and 95% by weight or less, based on the weight of the ceramic layer.

Since the ceramic layer contains the above content of the ceramic powder, lithium polysulfide, which is a reaction intermediate product on the positive electrode side and which is generated by repetition of charging and discharging, can be efficiently captured in the ceramic layer. As a result, the redox shuttle effect can be suppressed and the charging/discharging performance of the battery can be improved. If the ceramic powder content is less than 80%, the ionic/electronic conductivity is lowered and lithium polysulfide cannot be trapped inside it, which is undesirable.

The ceramic layer desirably contains 80% to 98% by weight of ceramic powder, 0% to 10% by weight of a conductive additive, and 1% to 10% by weight of a binder.

In several embodiments, the ceramic layer further contains a nitrogen-containing heterocyclic compound. The nitrogen-containing heterocyclic compound efficiently adsorbs lithium polysulfide in it. Therefore, by containing it together with the ceramic powder, the redox shuttle effect can be suppressed more efficiently and the charge/discharge performance of the battery can be improved. As the nitrogen-containing heterocyclic compound, for example, the same compounds as those mentioned as the materials for the sulfur layer can be used.

The ceramic layer contains, for example, a titanium-based composite oxide, which is ceramic powder, and a nitrogen-containing heterocyclic compound in a content ratio of 5:5.

The thickness of the ceramic layer may be any general thickness, for example, 1 μm to 50 μm as the value of an electrode taken from a battery with 100% SOC.

Incidentally, the positive electrode can be prepared, for example, in the following method. First, sulfur and/or a sulfur compound, which are the main positive electrode active materials described above, a lithium-containing oxide, a nitrogen-containing organic compound, a conductive additive, and a binder are dispersed in a solvent to prepare a sulfur layer slurry. Next, the sulfur layer slurry is applied to one or both surfaces of the positive electrode current collector and then dried to obtain a sulfur layer. As a result, the positive electrode including the positive electrode current collector and the sulfur layer can be prepared. Examples of the solvent used to prepare the sulfur layer slurry and the ceramic layer slurry include N-methyl-2-pyrrolidone (NMP) or water.

When preparing the positive electrode further including a ceramic layer, the positive electrode can be prepared, for example, in the following manner. The ceramic layer slurry is prepared by dispersing the above-mentioned ceramic material, conductive additive, and binder in the solvent. Next, the ceramic layer slurry is applied onto the dried sulfur layer, and then dried to form the ceramic layer.

### <Lithium-Sulfur Battery>

In several embodiments, the lithium-sulfur battery comprises the above-described positive electrode for a lithium-sulfur battery, a negative electrode which can store and release lithium ions, and a separator impregnated with a nonaqueous electrolyte solution.

### <Negative Electrode>

In several embodiments, the negative electrode contains a negative electrode active material. The negative electrode may also contain a negative electrode current collector.

The negative electrode current collector is not particularly limited, and any publicly known negative electrode current collector can be used. For example, rolled foil, electrolyte foil, and the like formed of copper or a copper alloy can be used. More specifically, the negative electrode current collector can be selected from a group consisting of copper, aluminum, stainless steel, titanium, silver, palladium, nickel, alloys thereof, and combinations thereof. Stainless steel may be surface treated with carbon, nickel, titanium, or silver, and examples of the alloys include aluminum-cadmium alloy and the like. Moreover, baked carbon, non-conductive polymer surface treated with a conductive material, conductive polymer, and the like can be used as the negative electrode current collector.

The negative electrode active material is not particularly limited as long as it is a material which can store/release lithium ions, and any publicly known material can be used. For example, the negative electrode active material is selected from metal materials such as metallic lithium, metallic sodium, a lithium aluminum alloy, a lithium tin alloy, a lithium silicon alloy, a sodium silicon alloy, a lithium antimony alloy, and a sodium antimony alloy, and, for example, carbon materials such as natural graphite, artificial graphite, carbon black, acetylene black, graphite, activated carbon, carbon fiber, coke, soft carbon, and hard carbon and, furthermore, oxide materials such as lithium titanate, and the like. One or more of the negative electrode active materials can be used. When two or more of the negative electrode active materials are used, their combination and ratio can be arbitrarily selected according to the purpose. The negative electrode active material is desirably metallic lithium or a lithium alloy.

In addition, the negative electrode may further contain a conductive additive to allow electrons to transfer smoothly within the negative electrode, together with the negative electrode active materials.

For example, carbon-based materials such as carbon black, acetylene black, ketjen black, carbon nanotubes (CNT), graphene, and reduced graphene oxide, or conductive polymers such as polyaniline, polythiophene, polyacetylene, and polypyrrole can be used as the conductive additive. The conductive additive is desirably contained in an amount of 0% to 20% by mass based on the total weight of the negative electrode active material layer. In addition, if the content of the conductive additive exceeds 20% by mass, the content of the negative electrode active material may become relatively small and the capacity performance of the battery may be degraded.

In addition, the negative electrode may further contain a binder which can play a role for a pasting of the negative electrode active material, the improvement in adhesion between the active materials or between the active material and the negative electrode current collector, and an effect of a buffer against expansion and contraction of the active material. More specifically, the material which is the same as the binder used for the sulfur layer can be used as the binder.

In several embodiments, the negative electrode does not comprise a separate negative electrode current collector and consists only of a rolled foil formed of lithium metal or a lithium alloy.

### <Nonaqueous Electrolyte Solution>

In several embodiments, the nonaqueous electrolyte solution contains an electrolyte composed of lithium salt, and a nonaqueous solvent.

Examples of the electrolyte include one or more mixtures selected from a group consisting of lithium salts such as lithium hexafluorophosphate (LiPF₆), lithium bromide (LiBr), lithium perchlorate (LiClO₄), lithium bisoxalate borate (LiB(C₂O₄)), lithium fluoroborate (LiBF₄), lithium nitrate (LiNO₃), lithium bis(fluorosulfonyl)imide (LiFSI), and lithium bis(trifluoromethanesulfonyl)imide (LiTFSI). When the mixtures are used, their combination and ratio can be arbitrarily selected according to the purpose.

In several embodiments, the nonaqueous solvent contains a cyclic ether and a chain ether as its main components. Examples of the cyclic ether include 1,3-dioxolane (DOL). Examples of the chain ether include dimethoxyethane (DME). The nonaqueous solvent may be, for example, a mixture of DOL and DME at a volume ratio of 1:1. When the nonaqueous solvent is a mixture of 1,3-dioxolane and dimethoxyethane, the high rate performance are particularly good.

The mixture of 1,3-dioxolane and dimethoxyethane, in which lithium polysulfide can easily be dissolved, has had problems with cycle performance in conventional lithium-sulfur batteries, but the problems can be solved by preventing the elution of lithium polysulfide by the electrode of the present invention.

In several embodiments, the nonaqueous solvent contains sulfolane (SL), dimethyl sulfoxide (DMSO), dimethyl sulfone, and the like as its main components.

In several embodiments, nonaqueous solvents include ethylene carbonate, ethylmethyl carbonate, propylene carbonate, dimethyl carbonate, diethyl carbonate, dimethoxyethane, sulfolane, oxolane, tetraglyme, triglyme, fluoroethylene carbonate, an ionic liquid, and the like. Examples of the ionic liquid include 1-ethyl-3-methylimidazolium bis(trifluoromethanesulfonyl)imide, 1-butyl-3-methylimidazolium bis(trifluoromethanesulfonyl)imide, 1-methyl-3-propylimidazolium bis(trifluoromethanesulfonyl)imide, 1-hexyl-3-methylimidazolium bis(trifluoromethanesulfonyl)imide, 1-ethyl-3-methylimidazolium chloride, 1-butyl-3-methylimidazolium chloride, 1-ethyl-3-methylimidazolium methanesulfonate, 1-butyl-3-methylimidazolium methanesulfonate, 1,2,3-trimethylimidazolium methylsulfate, methylimidazolium chloride, methylimidazolium hydrogen sulfate, 1-ethyl-3-methylimidazolium hydrogen sulfate, 1-butyl-3-methylimidazolium hydrogen sulfate, 1-ethyl-3-methylimidazolium tetrachloroaluminate, 1-butyl-3-methylimidazolium tetrachloroaluminate, 1-ethyl-3-methylimidazolium acetate, 1-butyl-3-methylimidazolium acetate, 1-ethyl-3-methylimidazolium ethyl sulfate, 1-butyl-3-methylimidazolium methyl sulfate, 1-ethyl-3-methylimidazolium thiocyanate, 1-butyl-3-methylimidazolium thiocyanate, 1-ethyl-2,3-dimethylimidazolium ethyl sulfate, 1-butylpyridinium bis(trifluoromethanesulfonyl)imide, 1-butyl-3-methylpyridinium bis(trifluoromethanesulfonyl)imide, 1-methyl-1-propylpyrrolidinium bis(trifluoromethanesulfonyl)imide, 1-butyl-1-methylpyrrolidinium bis(trifluoromethanesulfonyl)imide, tetrabutylphosphonium bis(trifluoromethanesulfonyl)imide, tributyldodecylphosphonium bis(trifluoromethanesulfonyl)imide, methyltributylammonium methyl sulfate, butyltrimethylammonium bis(trifluoromethanesulfonyl)imide, trimethyl hexylammonium bis(trifluoromethanesulfonyl)imide, and the like. As the nonaqueous solvent, one or a mixture of two or more liquids selected from the above group can be used, and when a mixture is used, the combination and ratio thereof can be arbitrarily selected depending on the purpose.

In several embodiments, the nonaqueous electrolyte solution desirably contains a small amount of lithium nitrate as a sub-electrolyte different from the main electrolyte if the main electrolyte is different from lithium nitrate. As a result, since lithium nitrate is reductively decomposed on the negative electrode to form a film derived from lithium nitrate, the reductive decomposition of lithium polysulfide can be suppressed by the film, degradation of the negative electrode can be suppressed, and the charge/discharge cycle performance can be improved. The electrolyte may contain, for example, 1 mol·dm⁻³ of LiTFSI as a main electrolyte and 1% by weight of lithium nitrate as a sub-electrolyte, based on the weight of the nonaqueous solvent.

### <Separator>

The separator may be either an organic polymer separator or an inorganic separator, and is composed of a material which does not react with the positive electrode active material, the negative electrode active material, the nonaqueous electrolyte solution, and the like. Examples of the organic polymer separator include microporous membranes or nonwoven fabrics such as polyolefin resins such as polyethylene resin and polypropylene resin, nitrocellulose resin and polyimide resin. Examples of the inorganic separator include silica glass nonwoven fabric, and the like. The separator may be subjected to treatments such as ceramic coating and structural control. One type or two or more types of the treatments may be performed, and a combination thereof can be arbitrarily selected depending on the purpose. The microporous membrane, nonwoven fabric, or the like may have a single layer or a multilayer structure. In addition, it may be a single sheet or may have other shapes such as a meandering shape.

### <Discharge Conditions>

In several embodiments, the lithium-sulfur battery discharges with a discharge cutoff potential of 1.0 V to 1.5 V (vs.Li/Li⁺). Discharging with the discharge cutoff potential in the above potential range means charging and discharging is performed with the above potential range as the lower limit of the discharge voltage.

Since the discharge cutoff potential is within the above range, for example, in a case where the ceramic powder contained in the ceramic layer is Li₄Ti₅O₁₂, which is a compound generally discharging at 1.55 V (vs. Li/Li⁺), it can function as a sub-positive electrode active material which stores lithium. Incidentally, sulfur and/or a sulfur compound which is the main positive electrode active material of the positive electrode generally discharges within a potential range of 2.4 V to 1.8 V (vs. Li/Li⁺). Thus, since Li₄Ti₅O₁₂ discharges simultaneously with the sulfur and/or sulfur compound which is the main positive electrode active material of the sulfur layer, the discharge capacity of the battery can be increased.

Furthermore, since the discharge of sulfur and/or sulfur compound continues at the same time as the potential at which Li₄Ti₅O₁₂ discharges, i.e., constant voltage discharge is performed, the sulfur and/or sulfur compound can react for a long time. As a result, the efficiency of use of sulfur as the positive electrode active material can be improved, discharging can be continued until the main positive electrode active material is fully discharged, and the discharge capacity of the battery incorporating the positive electrode can be improved.

The shape of the lithium-sulfur battery is not particularly limited, and may be, for example, a coin shape, a button shape, a sheet shape, a stacked type, a cylindrical shape, a square shape, a flat shape, and the like.

The lithium-sulfur battery according to embodiments will be described hereinafter with reference to the accompanying drawings.

FIG. 1 is a cross-sectional view showing an example of a lithium-sulfur battery according to a first embodiment.

A lithium-sulfur battery 1 comprises a positive electrode 2, a negative electrode 3, and a separator 4 provided between the positive electrode 2 and the negative electrode 3. The positive electrode 2, the negative electrode 3, and the separator 4 are housed in an exterior body (not shown).

The positive electrode 2 is composed of a positive electrode current collector 21 and a sulfur layer 22 provided on the surface thereof facing the separator 4. The negative electrode 3 is composed of a negative electrode current collector 31 and a negative electrode layer 32 provided on the surface thereof facing the separator 4. The separator 4 is impregnated with, for example, a nonaqueous electrolyte solution.

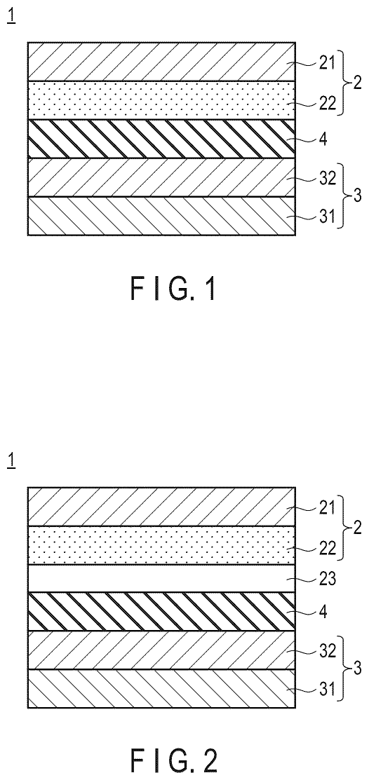

FIG. 2 is a cross-sectional view showing an example of a lithium-sulfur battery according to a second embodiment.

The lithium-sulfur battery according to the second embodiment is different from the first embodiment in that a positive electrode 2 further comprises a ceramic layer 23 laminated on a surface of a sulfur layer 22.

Incidentally, although the embodiments of the present invention have been specifically described, the present invention is not limited to these embodiments and examples, but can be variously changed based on the technical idea of the present invention.

The present invention will be described below in more detail with reference to Examples and Comparative Examples.

### Examples and Comparative Examples

### [Preparation of Positive Electrode of Example 1]

Sulfur(S) and ketjen black (KB) were mixed at a weight ratio of 70:30. Next, the obtained mixture was heat-treated at 155° C. for 12 hours under an inert gas atmosphere to infiltrate sulfur into pores of ketjen black and prepare a sulfur-carbon composite material (S/KB composite material).

The sulfur carbon composite material (S/KB composite material), acetylene black (AB) and carbon nanotube (CNT) that are conductive additives, carboxymethyl cellulose (CMC) that is a binder, and Li₄Ti₅O₁₂ that is a lithium-containing oxide, and sulfurized polyacrylonitrile that is a nitrogen-containing organic compound, were added to ultrapure water that is a solvent, and mixed and dispersed to prepare a positive electrode slurry. For mixing, a defoaming stirring device “Awatori Rentaro” manufactured by Thinky Co., Ltd. was used.

Next, the prepared positive electrode slurry was applied onto a carbon-coated aluminum foil that is a positive electrode current collector using a coating machine, and was dried to form a sulfur layer. Applying the positive electrode slurry was performed such that the amount of sulfur supported in the sulfur layer was 3.5 mg·cm⁻². Drying was performed under vacuum at 60° C. overnight. The composition (weight ratio) of the sulfur layer was S/KB composite material:AB:CNT:binder:Li₄Ti₅O₁₂:sulfurized polyacrylonitrile=85:1:2:5:3:4. The sulfur content is 60% by weight based on the weight of the sulfur layer.

### [Preparation of Positive Electrodes of Examples 2 to 5]

The positive electrodes of Examples 2, 3, 4, and 5 were prepared in the same preparing method as that of the above-described positive electrode of Example 1 except that the nitrogen-containing organic compounds in the sulfur layer were replaced with cyclic polyacrylonitrile, poly(N-vinylcarbazole), poly(N-vinylpyridine), and poly(N-vinylpyrrolidone), which are the nitrogen-containing heterocyclic compounds, respectively.

### [Preparation of Positive Electrodes of Examples 6 and 7]

The positive electrode of Example 6 was prepared in the same preparing method as the above-described positive electrode of Example 1 except that the lithium-containing oxide in the sulfur layer was changed to Li₇La₃Zr₂O₁₂.

The positive electrode of Example 7 was prepared in the same preparing method as the above-described positive electrode of Example 1.

### [Preparation of Positive Electrode of Comparative Example 1]

The positive electrode of Comparative Example 1 was prepared in the same preparing method as the above-described positive electrode of Example 1 except that each of the contents of the lithium-containing oxide and the nitrogen-containing organic compound in the sulfur layer was changed to 0% by weight. The composition (weight ratio) of the sulfur layer was S/KB composite material:AB:CNT:binder=92:1:2:5. The sulfur content was 64% by weight based on the weight of the sulfur layer.

### [Preparation of Positive Electrodes of Comparative Examples 2 and 3]

The positive electrodes of Comparative Examples 2 and 3 were prepared in the same preparing method as the above-described positive electrode of Example 1 except that the contents of the lithium-containing oxide in the sulfur layer were changed to 7% by weight and 0% by weight, respectively and that the contents of the nitrogen-containing organic compound were changed to 0% by weight and 7% by weight, respectively.

The composition (weight ratio) of the sulfur layer, Li₄Ti₅O₁₂:nitrogen-containing organic compound, is 7:0 in Comparative Example 2 and 0:7 in Comparative Example 3.

### [Preparation of Positive Electrodes of Comparative Examples 4 to 6]

The positive electrodes of Comparative Examples 4, 5, and 6 were prepared in the same preparing method as the above-described positive electrode of Example 1 except that the organic compounds in the sulfur layer were changed to polyvinyl alcohol, polyacrylonitrile, and polyethyleneimine, which were not nitrogen-containing heterocyclic compounds, respectively.

### [Preparation of Positive Electrode of Comparative Example 7]

The positive electrode of Comparative Example 7 was prepared in the same preparing method as the above-described positive electrode of Example 1 except that the oxide in the sulfur layer was changed to Al₂O₃, which is a lithium-free oxide.

### [Preparation of Positive Electrode of Example 8]

The positive electrode of Example 8 was prepared in the same preparing method as the above-described positive electrode of Example 1 except that the positive electrode slurry was applied such that the amount of sulfur supported in the sulfur layer was 5.0 mg·cm⁻². By increasing the amount of supported sulfur compared to Examples 1 to 7, the discharge capacity can hardly be obtained especially when a high current is applied, in the lithium-sulfur battery comprising the positive electrode. Experiments were conducted under these conditions in order to obtain variation in results depending on the composition (weight ratio) of the lithium-containing oxide and the nitrogen-containing organic compound.

### [Preparation of Positive Electrodes of Examples 9 to 12]

The positive electrodes of Examples 9, 10, 11, and 12 were prepared in the same preparing method as the above-described positive electrode of Example 8 except that the contents of the lithium-containing oxide in the sulfur layer were changed to 3.5% by weight, 4% by weight, 5% by weight, and 6% by weight, respectively, and that the contents of the nitrogen-containing organic compound were changed to 3.5% by weight, 3% by weight, 2% by weight, and 1% by weight, respectively. The composition (weight ratio) of the sulfur layer, Li₄Ti₅O₁₂:nitrogen-containing organic compound, is 3.5:3.5 in Example 9, 4:3 in Example 10, 5:2 in Example 11, and 6:1 in Example 12.

### [Preparation of Positive Electrode of Example 13]

The positive electrode of Example 13 was prepared in the same preparing method as the above-described positive electrode of Example 10 except that the lithium-containing oxide in the sulfur layer was changed to Li₇La₃Zr₂O₁₂.

### [Preparation of Positive Electrodes of Examples 14 to 16]

The positive electrodes of Examples 14, 15, and 16 were prepared in the same preparing method as the above-described positive electrode of Example 10 except that the nitrogen-containing organic compounds in the sulfur layer were changed to cyclic polyacrylonitrile, poly(N-vinylcarbazole), and poly(N-vinylpyridine), respectively.

### [Preparation of Positive Electrodes of Examples 17 to 22]

The positive electrodes of Examples 17 to 22 were prepared in the same preparing method as the above-described positive electrode of Example 1 except that the contents of the lithium-containing oxide in the sulfur layer were changed to 0.2% by weight, 0.4% by weight, 1.3% by weight, 4.3% by weight, 6.4% by weight, and 8.6% by weight, respectively, that the contents of the nitrogen-containing organic compound were changed to 0.3% by weight, 0.6% by weight, 1.7% by weight, 5.7% by weight, 8.6% by weight, and 11.4% by weight, respectively, and that the total contents of Li₄Ti₅O₁₂ and the nitrogen-containing organic compound were changed to 0.5% by weight, 1% by weight, 3% by weight, 10% by weight, 15% by weight, and 20% by weight, respectively. The composition (weight ratio) of the sulfur layer, Li₄Ti₅O₁₂:nitrogen-containing organic compound, is 0.2:0.3 in Example 17, 0.4:0.6 in Example 18, 1.3:1.7 in Example 19, 4.3:5.7 in Example 20, 6.4:8.6 in Example 21, and 8.6:11.4 in Example 22.

### [Preparation of Positive Electrode of Example 23]

The positive electrode of Example 23 is different from the positive electrode of Example 8 in further comprising a ceramic layer laminated on the surface of the sulfur layer. The positive electrode of Example 23 was prepared in the same preparing method as the above-described positive electrode of Example 1 except the elements to be described below.

Applying the positive electrode slurry was performed such that the amount of sulfur supported in the sulfur layer was 5.0 mg·cm⁻². For drying after coating the positive electrode slurry, vacuum drying was performed at 60° C. for 1 hour.

Next, Li₄Ti₅O₁₂ powder, which is ceramic powder, AB, which is a conductive additive, and CMC, which is a binder, were added to ultrapure water, which is a solvent, and mixed and dispersed to prepare the ceramic layer slurry. Next, the prepared ceramic layer slurry was applied onto the dried sulfur layer using a coating machine and was dried to form a ceramic layer. Drying was performed under vacuum at 60° C. overnight. The composition (weight ratio) of the ceramic layer was Li₄Ti₅O₁₂:AB:binder=90:5:5. Next, the ceramic layer was pressed and punched.

The positive electrode of Example 23 comprising the sulfur layer and the ceramic layer laminated on the surface of the sulfur layer was prepared through the above-described steps.

### [Preparation of Positive Electrodes of Examples 24 to 26]

The positive electrodes of Examples 24, 25, and 26 were prepared in the same preparing method as the above-described positive electrode of Example 23 except that the contents of the lithium-containing oxide in the sulfur layer were changed to 3.5% by weight, 4% by weight, and 6% by weight, respectively, and that the contents of the nitrogen-containing organic compound were changed to 3.5% by weight, 3% by weight, and 1% by weight, respectively.

The composition (weight ratio) of the sulfur layer, Li₄Ti₅O₁₂:nitrogen-containing organic compound, is 3.5:3.5 in Example 24, 4:3 in Example 25, and 6:1 in Example 26.

### [Preparation of Positive Electrodes of Examples 27 to 29]

The positive electrodes of Examples 27, 28, and 29 were prepared in the same preparing method as the above-described positive electrode of Example 26 except that the content of the ceramic material in the ceramic layer was changed to 45% by weight and that the content of the nitrogen-containing heterocyclic compound was changed to 45% by weight. As the nitrogen-containing heterocyclic compound in the ceramic layer, sulfurized polyacrylonitrile was used in Example 27, poly(N-vinylcarbazole) was used in Example 28, and poly(N-vinylpyridine) was used in Example 29.

The composition (weight ratio) of the ceramic layer was Li₄Ti₅O₁₂:nitrogen-containing heterocyclic compound:AB:binder=45:45:5:5.

### [Preparation of Positive Electrode of Comparative Example 8]

The positive electrode of Comparative Example 8 was prepared in the same preparing method as the above-described positive electrode of Example 23 except that each of the contents of the lithium-containing oxide and the nitrogen-containing organic compound in the sulfur layer was changed to 0% by weight.

The composition (weight ratio) of the sulfur layer was S/KB composite material:AB:CNT:binder=92:1:2:5. The sulfur content was 64% by weight based on the weight of the sulfur layer.

### [Preparation of Positive Electrodes of Comparative Examples 9 and 10]

The positive electrodes of Comparative Examples 9 and 10 were prepared in the same preparing method as the above-described positive electrode of Example 23 except that the contents of the lithium-containing oxide in the sulfur layer were changed to 7% by weight and 0% by weight, respectively and that the contents of the nitrogen-containing organic compound were changed to 0% by weight and 7% by weight, respectively.

The composition (weight ratio) of the sulfur layer, Li₄Ti₅O₁₂:nitrogen-containing organic compound, was 7:0 in Comparative Example 9 and 0:7 in Comparative Example 10.

### <Preparation of Nonaqueous Electrolyte Solutions>

The nonaqueous electrolyte solutions other than Example 7 were prepared by mixing lithium bis(trifluoromethane) sulfonimide (LiTFSI), which is a main electrolyte, at 1 mol/dm³ and LiNO₃, which is a sub-electrolyte, at 1% by weight based on the weight of the nonaqueous solvent, with the nonaqueous solvent. As the nonaqueous solvent, a mixture of 1,3-dioxolane (DOL) and 1,2-dimethoxyethane (DME) at a volume ratio of 1:1 was used.

The nonaqueous electrolyte solution of Example 7 was prepared in the same manner as the above-described nonaqueous electrolyte except that LiNO₃ which is a subelectrolyte was not added.

### [Assembly of Test Cell]

A coin-shaped test cells were assembled using the prepared positive electrodes of Examples 1 to 29 and Comparative Examples 1 to 10 and a negative electrode. The negative electrode in which lithium metal serving as a negative electrode active material was deposited on copper foil serving as a negative electrode current collector, was used. Inside the exterior body, each positive electrode and the negative electrode were arranged with a separator impregnated with an electrolyte solution interposed therebetween. The electrode area of each positive electrode is 1.583 cm². A PP separator manufactured by Celgard was used as the separator, and was impregnated with the prepared nonaqueous electrolyte solution.

Table 1 shows below materials of the oxides and the organic compounds contained in the sulfur layers of Examples 1 to 7 and Comparative Examples 1 to 7, their contents, results of evaluation tests of discharge capacities mentioned below, and results of charge/discharge cycle tests mentioned below. In the positive electrode shown in Table 1, the amount of sulfur supported in the sulfur layer is 3.5 mgcm⁻².

TABLE 1

| | | | Oxides: | | | | Capacity |
|---|---|---|---|---|---|---|---|
| | | | Organic | Discharge capacities | | | retention |
| | | | compounds | [mAhg⁻¹] | | | rates |
| | Oxides | Organic compounds | [wt. %] | 0.9 mA | 4.5 mA | 9.0 mA | [%] |
| Example | Li₄Ti₅O₁₂ | Sulfur-modified | 3:4 | 620 | 569 | 535 | 65 |
| 1 | | polyacrylonitrile | | | | | |
| Example | Li₄Ti₅O₁₂ | Cyclic | 3:4 | 609 | 525 | 476 | 64 |
| 2 | | polyacrylonitrile | | | | | |
| Example | Li₄Ti₅O₁₂ | Poly | 3:4 | 614 | 551 | 530 | 66 |
| 3 | | (N-vinylcarbazole) | | | | | |
| Example | Li₄Ti₅O₁₂ | Poly | 3:4 | 602 | 522 | 489 | 70 |
| 4 | | (N-vinylpyridine) | | | | | |
| Example | Li₄Ti₅O₁₂ | Poly | 3:4 | 610 | 546 | 504 | 63 |
| 5 | | (N-vinylpyrrolidone) | | | | | |
| Example | Li₇La₃Zr₂O₁₂ | Sulfur-modified | 3:4 | 597 | 531 | 490 | 64 |
| 6 | | polyacrylonitrile | | | | | |
| Example | Li₄Ti₅O₁₂ | Sulfur-modified | 3:4 | 611 | 555 | 491 | 53 |
| 7 | | polyacrylonitrile | | | | | |
| Comparative | No | No | — | 541 | 126 | 66 | 12 |
| example 1 | additives | additives | | | | | |
| Comparative | Li₄Ti₅O₁₂ | No | 7:0 | 546 | 171 | 93 | 35 |
| example 2 | | additives | | | | | |
| Comparative | No | Sulfur-modified | 0:7 | 425 | 221 | 118 | 44 |
| example 3 | additives | polyacrylonitrile | | | | | |
| Comparative | Li₄Ti₅O₁₂ | Polyvinyl alcohol | 3:4 | 527 | 135 | 70 | 51 |
| example 4 | | | | | | | |
| Comparative | Li₄Ti₅O₁₂ | Polyacrylonitrile | 3:4 | 551 | 215 | 89 | 56 |
| example 5 | | | | | | | |
| Comparative | Li₄Ti₅O₁₂ | Polyethylenimine | 3:4 | 527 | 278 | 107 | 53 |
| example 6 | | | | | | | |
| Comparative | Al₂O₃ | Sulfur-modified | 3:4 | 593 | 381 | 238 | 64 |
| example 7 | | polyacrylonitrile | | | | | |

Table 2 shows below materials of the oxides and the organic compounds contained in the sulfur layers of Examples 8 to 16, their contents, and results of evaluation tests of discharge capacities mentioned below. In the positive electrode shown in Table 2, the amount of sulfur supported in the sulfur layer is 5.0 mgcm⁻².

TABLE 2

| | | | | Discharge | |
|---|---|---|---|---|---|
| | | | Oxides:Or- | capacities | |
| | | | ganic | [mAhg⁻¹] | |
| | | Organic | compounds | 1.3 | 6.5 |
| | Oxides | compounds | [wt. %] | mA | mA |
| Exam- | Li₄Ti₅O₁₂ | Sulfur-modified | 3:4 | 623 | 218 |
| ple 8 | | polyacrylonitrile | | | |
| Exam- | Li₄Ti₅O₁₂ | Sulfur-modified | 3.5:3.5 | 612 | 488 |
| ple 9 | | polyacrylonitrile | | | |
| Exam- | Li₄Ti₅O₁₂ | Sulfur-modified | 4:3 | 606 | 512 |
| ple 10 | | polyacrylonitrile | | | |
| Exam- | Li₄Ti₅O₁₂ | Sulfur-modified | 5:2 | 616 | 529 |
| ple 11 | | polyacrylonitrile | | | |
| Exam- | Li₄Ti₅O₁₂ | Sulfur-modified | 6:1 | 615 | 536 |
| ple 12 | | polyacrylonitrile | | | |
| Exam- | Li₇La₃Zr₂O₁₂ | Sulfur-modified | 4:3 | 610 | 504 |
| ple 13 | | polyacrylonitrile | | | |
| Exam- | Li₄Ti₅O₁₂ | Cyclic | 4:3 | 583 | 504 |
| ple 14 | | polyacrylonitrile | | | |
| Exam- | Li₄Ti₅O₁₂ | Poly | 4:3 | 592 | 499 |
| ple 15 | | (N- | | | |
| | | vinylcarbazole) | | | |
| Exam- | Li₄Ti₅O₁₂ | Poly | 4:3 | 587 | 495 |
| ple 16 | | (N- | | | |
| | | vinylpyridine) | | | |

Table 3 shows below materials of the oxides and the organic compounds contained in the sulfur layers of Examples 17 to 22, their contents, total contents of the oxides and the organic compounds, rates of sulfur contained in the sulfur layers, results of evaluation tests of discharge capacities mentioned below, and results of charge/discharge cycle tests mentioned below. In Table 3, the amount of sulfur supported in the sulfur layer is all 3.5 mgcm⁻², and the sulfur layers are different in thickness.

TABLE 3

| | | | | | Rates of | | | | |
|---|---|---|---|---|---|---|---|---|---|
| | | | | | sulfur | | | | |
| | | | | Total | contained | | | | |
| | | | Oxides: | content | in sulfur | Discharge | | | Capacity |
| | | | Organic | of oxide and | mixture | capacities | | | retention |
| | | | compounds | organic compound | layer | [mAhg⁻¹] | | | rates |
| | Oxides | Organic compounds | [wt. %] | [wt. %] | [wt. %] | 0.9 mA | 4.5 mA | 9.0 mA | [%] |
| Example | Li₄Ti₅O₁₂ | Sulfur-modified | 0.2:0.3 | 0.5 | 64 | 602 | 320 | 210 | 34 |
| 17 | | polyacrylonitrile | | | | | | | |
| Example | Li₄Ti₅O₁₂ | Sulfur-modified | 0.4:0.6 | 1 | 64 | 650 | 583 | 555 | 63 |
| 18 | | polyacrylonitrile | | | | | | | |
| Example | Li₄Ti₅O₁₂ | Sulfur-modified | 1.3:1.7 | 3 | 62 | 649 | 596 | 560 | 66 |
| 19 | | polyacrylonitrile | | | | | | | |
| Example | Li₄Ti₅O₁₂ | Sulfur-modified | 4.3:5.7 | 10 | 57 | 598 | 549 | 516 | 67 |
| 20 | | polyacrylonitrile | | | | | | | |
| Example | Li₄Ti₅O₁₂ | Sulfur-modified | 6.4:8.6 | 15 | 54 | 582 | 515 | 485 | 70 |
| 21 | | polyacrylonitrile | | | | | | | |
| Example | Li₄Ti₅O₁₂ | Sulfur-modified | 8.6:11.4 | 20 | 50 | 580 | 482 | 453 | 68 |
| 22 | | polyacrylonitrile | | | | | | | |

Table 4 shows below materials of the oxides and the organic compounds contained in the sulfur layers of Examples 23 to 29 and Comparative Examples 8 to 10, their contents, materials contained in the ceramic layer, results of evaluation tests of discharge capacities mentioned below, and results of charge/discharge cycle tests mentioned below. In the positive electrode shown in Table 3, the amount of sulfur supported in the sulfur layer is 5.0 mgcm⁻².

TABLE 4

| | | | | | | Discharge | |
|---|---|---|---|---|---|---|---|
| | | | Oxides: | Materials | | capacities | Capacity |
| | | | Organic | contained | Discharge | in 100th | retention |
| | | | compounds | in ceramic | capacities | cycle | rates |
| | Oxides | Organic compounds | [wt. %] | layer | [mAhg⁻¹] | [mAhg⁻¹] | [%] |
| Example | Li₄Ti₅O₁₂ | Sulfur-modified | 3:4 | Li₄Ti₅O₁₂ | 587 | 507 | 86 |
| 23 | | polyacrylonitrile | | | | | |
| Example | Li₄Ti₅O₁₂ | Sulfur-modified | 3.5:3.5 | Li₄Ti₅O₁₂ | 591 | 511 | 86 |
| 24 | | polyacrylonitrile | | | | | |
| Example | Li₄Ti₅O₁₂ | Sulfur-modified | 4:3 | Li₄Ti₅O₁₂ | 599 | 506 | 84 |
| 25 | | polyacrylonitrile | | | | | |
| Example | Li₄Ti₅O₁₂ | Sulfur-modified | 6:1 | Li₄Ti₅O₁₂ | 603 | 501 | 83 |
| 26 | | polyacrylonitrile | | | | | |
| Example | Li₄Ti₅O₁₂ | Sulfur-modified | 6:1 | Li₄Ti₅O₁₂/ | 607 | 515 | 85 |
| 27 | | polyacrylonitrile | | Sulfur-modified | | | |
| | | | | polyacrylonitrile | | | |
| Example | Li₄Ti₅O₁₂ | Sulfur-modified | 6:1 | Li₄Ti₅O₁₂/ | 573 | 474 | 83 |
| 28 | | polyacrylonitrile | | Poly | | | |
| | | | | (N-vinylcarbazole) | | | |
| Example | Li₄Ti₅O₁₂ | Sulfur-modified | 6:1 | Li₄Ti₅O₁₂/ | 570 | 490 | 86 |
| 29 | | polyacrylonitrile | | Poly | | | |
| | | | | (N-vinylpyridine) | | | |
| Comparative | Li₄Ti₅O₁₂ | Sulfur-modified | — | Li₄Ti₅O₁₂ | 491 | 249 | 51 |
| example 8 | | polyacrylonitrile | | | | | |
| Comparative | Li₄Ti₅O₁₂ | Sulfur-modified | 7:0 | Li₄Ti₅O₁₂ | 579 | 292 | 50 |
| example 9 | | polyacrylonitrile | | | | | |
| Comparative | Li₄Ti₅O₁₂ | Sulfur-modified | 0:7 | Li₄Ti₅O₁₂ | 456 | 201 | 44 |
| example 10 | | polyacrylonitrile | | | | | |
| Comparative | Li₄Ti₅O₁₂ | Sulfur-modified | 6:1 | No | 615 | 231 | 38 |
| example 11 | | polyacrylonitrile | | ceramic layer | | | |

### <Discharge Capacity Evaluation Test>

As shown in Tables 1 to 4, a discharge capacity evaluation test was conducted for each evaluation cell of Examples 1 to 29 and Comparative Examples 1 to 10. The test was conducted in an environment of an ambient temperature of 60° C.

For each evaluation cell in Table 1, constant current discharge was performed until the voltage reached 1.0 V at 0.9 mA (0.1 C), 4.5 mA (0.5 C), and 9.0 mA (1.0 C).

For each evaluation cell in Table 2, constant current discharge was performed until the voltage reached 1.0 V at 1.3 mA (0.1 C) and 6.5 mA (0.5 C).

For each evaluation cell in Table 3, constant current discharge was performed until the voltage reached 1.0 V at 0.9 mA (0.1 C), 4.5 mA (0.5 C), and 9.0 mA (1.0 C).

For each evaluation cell in Table 4, constant current discharge was performed until the voltage reached 1.0 V at 1.3 mA (0.1 C).

These results are shown in Tables 1 to 4. The discharge capacity was shown as a value normalized based on the weight of the positive electrode.

### <Charge/Discharge Cycle Test>

A charge/discharge cycle test was conducted on each evaluation cell of Examples 1 to 7 and Comparative Examples 1 to 7 in Table 1, Examples 17 to 22 in Table 3, and Examples 23 to 29 and Comparative Examples 8 to 10 in Table 4. The tests was conducted in an environment of an ambient temperature of 60° C.

First, in each evaluation cell in Table 1, constant current discharge was performed until the voltage reached 1.0 V at 0.9 mA (0.1 C). Next, for each test cell, constant current charge was performed until the voltage reached 3.0 V at the same current density. Charging and discharging were repeated 100 cycles by regarding this charging and discharging as one cycle. After that, the capacity retention rate was calculated using the following formula. The results are shown in Table 1.

$$Capacity retention rate ( \% ) = discharge capacity in 100 th cycle / \\ discharge capacity in first cycle$$

For each test cell shown in Table 3, the test was conducted in the same manner as that in Table 1.

For each test cell in Table 4, the test was conducted in the same manner except that the constant current charging and constant current discharging were performed at a current density of 1.3 mA (0.1 C).

These results are shown in Tables 1 and 3.

Based on the results in Tables 1 to 4, in particular, in the test cells of Examples 1 to 29, since the sulfur layer contained both the lithium-containing oxide and the nitrogen-containing organic compound and since the nitrogen-containing organic compound was the nitrogen-containing heterocyclic compound, a high discharge capacity was exhibited at any current value, and a good capacity retention rate was obtained.

Based on the results in Table 1, in the test cells of Comparative Examples 1 to 3, since the sulfur layer did not contain the lithium-containing oxide and the nitrogen-containing organic compound, the discharge capacity was significantly reduced particularly when applying a high current as compared to Examples 1 to 7.

Incidentally, in Example 1 in which the lithium-containing oxide was Li₄Ti₅O₁₂, a more desirable discharge capacity was obtained than that in Example 6 in which the lithium-containing oxide was Li₇La₃Zr₂O₁₂, thanks to its higher lithium ion conductivity. In contrast, in Comparative Example 7 containing Al₂O₃ which is a lithium-free oxide, the discharge capacity was significantly reduced when a high current was applied, as compared to Examples 1 to 7. In addition, in Comparative Examples 4 to 6 in which the sulfur layer did not contain a nitrogen-containing heterocyclic compound but contained the other polymers, the discharge capacity was significantly reduced when a high current was applied, as compared to Examples 1 to 7. It can be understood from these results that the high rate performance are improved when the sulfur layer contains a lithium-containing oxide and a nitrogen-containing heterocyclic compound.

Based on the results in Table 2, in the test cells of Examples 8 to 16, when the content of the lithium-containing oxide is represented by A and the content of the nitrogen-containing organic compound is represented by B, a more desirable discharge capacity was obtained when a high current was applied (6.5 mA) since A≥B. For the test cells of Examples 13 to 16, the material of the oxide or the organic compound material in the sulfur layer was changed from Examples 8 to 12, but similar results were obtained.

In addition, it can be understood by comparing the results of the test cells of Examples 8 to 16 that the larger the ratio of the lithium-containing oxide content (A) in the sulfur layer, the better the discharge capacity when a high current is applied.

Based on the results in Table 3, in all of Examples 17 to 22 in which the total content of lithium-containing oxides and nitrogen-containing organic compounds contained in the sulfur layer was in the range of 0.5% to 20% by weight, a desirable capacity retention rate was obtained as compared to Comparative Example 1 in Table 1. In Example 17, although the total content of the lithium-containing oxide and the nitrogen-containing organic compound was as small as 0.5% by weight, the same capacity retention rate as that in Comparative Example 2 in which only the lithium-containing oxide was contained at 7.0% by weight, was obtained. In addition, in Example 17, the capacity retention rate of approximately 75% was obtained as compared to the capacity retention rate of Comparative Example 3 in which only the nitrogen-containing organic compound was contained at 7.0% by weight. Furthermore, in Example 18 in which the total content of the lithium-containing oxide and the nitrogen-containing organic compound was 1% by weight, the capacity retention rate higher than that of Comparative Example 3 was obtained. Therefore, it can be understood that by containing both a lithium-containing oxide and a nitrogen-containing organic compound in the sulfur layer, at equivalent contents, a desirable capacity retention rate can be obtained as compared to a case where either the lithium-containing oxide or the nitrogen-containing organic compound is contained.

In addition, it can also be understood that the capacity retention rate is more desirable in Examples 18 to 22 in which the content is 1% by weight or more. In addition, it can be understood by comparing the results of the test cells of Examples 17 to 22 that the lower the rate of sulfur contained in the sulfur layer, the lower the discharge capacity per positive electrode weight. In order to increase the discharge capacity, the smaller the amount of sulfur supported per unit area, the thicker the sulfur layer needs to be coated, but the discharge capacity is assumed to be smaller since lithium ions are more unlikely to be transferred into the sulfur layer as the sulfur layer becomes thicker. Therefore, the total content of the lithium-containing oxide and the nitrogen-containing organic compound is desirably 1% by weight or more and 20% by weight or less, based on the weight of the sulfur layer.

Based on the results in Table 4, in Examples 23 to 29 in which the ceramic layer was laminated on the surface of the sulfur layer, more desirable capacity retention rates were obtained as compared to Examples 1 to 7 in Table 1.

In contrast, in the test cells of Comparative Examples 8 to 10, the capacity retention rate was significantly lowered as compared to Examples 23 to 29 since the sulfur layer did not contain either the lithium-containing oxide or the nitrogen-containing organic compound.

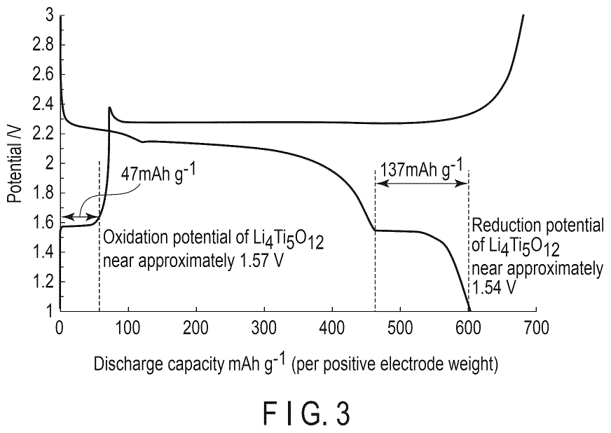

The charge/discharge curve of Example 26 is shown in FIG. 3. Since the ceramic powder contained in the ceramic layer is Li₄Ti₅O₁₂, the layer is hereinafter referred to as a Li₄Ti₅O₁₂ layer. In the charge/discharge curve of the lithium-sulfur battery incorporating the Li₄Ti₅O₁₂ layer, a potential flat part where the potential becomes constant at near 1.55 V (vs. Li/Li+) can be confirmed. Since the oxidation/reduction potential of Li₄Ti₅O₁₂ is 1.55 V and since the charge/discharge curve is shifted to the high potential side when a charge current is passed or to the low potential side when a discharge current is passed, due to overvoltage of the battery, it can be presumed that the potential flat part of the discharge curve at 1.54 V and the potential flat part of the charge curve at 1.57 V are derived from oxidation and reduction of Li₄Ti₅O₁₂. When the discharge capacity of the charge/discharge curve near 1.55 V (vs.Li/Li⁺) is focused, the capacity component of 137 mAhg⁻¹ can be confirmed from the discharge curve, as the discharge capacity per positive electrode weight, at 1.54 V (vs. Li/Li⁺). In contrast, the capacity component of 47 mAhg⁻¹ can be confirmed as the charging capacity per positive electrode weight, at 1.57 V (vs. Li/Li⁺), from the charging curve. It can be understood from these results that the discharge capacity is larger than the charge capacity.

Since the capacity component of Li₄Ti₅O₁₂ in this test corresponds to approximately 47 mAhg⁻¹ in the curve, it can be presumed that the capacity component of 1.54 V (vs. Li/Li⁺) in the charge curve is the capacity component derived from oxidation of Li₄Ti₅O₁₂. In contrast, since the capacity higher than or equal to the capacity component (approximately 47 mAhg⁻¹) possessed by Li₄Ti₅O₁₂ could be confirmed from the discharge curve, it can be presumed that a capacity component is added in which unreacted sulfur and sulfur compounds reacted simultaneously in addition to the reduction of Li₄Ti₅O₁₂ by forming the Li₄Ti₅O₁₂ layer. Based on the above, it is considered that in the positive electrode incorporating the Li₄Ti₅O₁₂ layer, the sulfur utilization rate was improved since Li₄Ti₅O₁₂ reduced during discharge reacted with unreacted sulfur. In addition, if the ceramic material is a material that is oxidized and reduced in the potential range of 1.0 V (vs.Li/Li⁺) to 3.0 V (vs.Li/Li⁺), unreacted sulfur is presumed to react in the same manner and, therefore, the same effects can be expected.

Based on the above results, it was suggested that in the positive electrode incorporating the ceramic layer, the capacity is significantly increased by discharging the voltage to a value of 1.0 V (vs. Li/Li⁺) or more and 1.5 V (vs. Li/Li⁺) or less at which the ceramic powder contained in the ceramic layer can be sufficiently reduced.

As a result, according to the configuration of the present invention, the lithium-sulfur battery positive electrode and the lithium-sulfur battery capable of simultaneously achieving the improvement in discharge rate performance and the enhancement in charge/discharge cycle performance can be provided.

The present invention may comprise the following features.

In a first aspect, a lithium-sulfur battery positive electrode according to one embodiment comprises a positive electrode current collector and a sulfur layer deposited on the surface of the positive electrode current collector, the sulfur layer contains sulfur and/or a sulfur compound as a main positive electrode active material, and a lithium-containing oxide and a nitrogen-containing organic compound, and the nitrogen-containing organic compound is a nitrogen-containing heterocyclic compound.

In a second aspect, in addition to the first aspect, the nitrogen-containing heterocyclic compound may be a compound containing a pyridine cyclic skeleton.

In a third aspect, in addition to the first aspect or the second aspect, when the content of the lithium-containing oxide is A and the content of the nitrogen-containing organic compound is B in the sulfur layer, it may be possible that A≥B.

In a fourth aspect, in addition to any one of the first to third aspects, the lithium-containing oxide may be composed of a compound which charges and discharges within a potential range of more than 1.0 V (vs. Li/Li⁺) and less than 3.0 V (vs. Li/Li⁺).

In a fifth aspect, in addition to any one of the first to fourth aspects, the lithium-containing oxide may be a lithium-titanium composite oxide.

In a sixth aspect, in addition to any one of the first to fifth aspects, the nitrogen-containing organic compound may be a compound which charges and discharges within a potential range of more than 1.0 V (vs. Li/Li⁺) and less than 3.0 V (vs. Li/Li⁺).

In a seventh aspect, in addition to any one of the first to sixth aspects, the nitrogen-containing organic compound may be sulfurized polyacrylonitrile or a derivative thereof.

In an eighth aspect, in addition to any one of the first to seventh aspects, the sulfur layer may further contain a carbon-based conductive additive.

In a ninth aspect, in addition to any one of the first to eighth aspects, the total content of the lithium-containing oxide and the nitrogen-containing organic compound may be 1% by weight or more and 20% by weight or less, based on the weight of the sulfur layer.

In a tenth aspect, in addition to any one of the first to ninth aspects, the lithium-sulfur battery positive electrode may further comprise a ceramic layer laminated on the sulfur layer, and the ceramic layer may contain ceramic powder as a main component.

In an eleventh aspect, in addition to any one of the first to tenth aspects, the ceramic powder may be composed of titanium oxide or a titanium-based composite oxide.

In a twelfth aspect, in addition to any one of the first to eleventh aspects, the ceramic layer may further contain a nitrogen-containing heterocyclic compound.

In a thirteenth aspect, the lithium-sulfur battery according to one embodiment comprises a lithium-sulfur battery positive electrode that satisfies any one of the first to twelfth aspects, a negative electrode which can store and release lithium ions, and a separator impregnated with a nonaqueous electrolyte solution.

In a fourteenth aspect, in addition to being the lithium-sulfur battery according to the thirteenth aspect, the nonaqueous electrolyte solution may contain an electrolyte formed of lithium salt and a nonaqueous solvent, and the nonaqueous solvent may be a mixture of 1,3-dioxolane and dimethoxyethane.

In the fifteenth aspect, in addition to being the lithium-sulfur battery according to the thirteenth aspect or the fourteenth aspect, the nonaqueous electrolyte solution may further contain lithium nitrate as a sub-electrolyte separate from the main electrolyte that is the main component of the electrolyte.

In the charging/discharging method of the above-described lithium-sulfur battery according to one embodiment, discharging is performed by setting the lower limit of the discharge voltage to 1.0 V (vs. Li/Li⁺) or more and 1.5 V (vs. Li/Li⁺) or less for the lithium-sulfur battery which satisfies any one of the thirteenth to fifteenth aspects.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lithium-sulfur battery positive electrode, comprising:
a positive electrode current collector; and
a sulfur layer deposited on a surface of the positive electrode current collector, wherein
the sulfur layer contains sulfur and/or a sulfur compound which is a main positive electrode active material, a lithium-containing oxide, and a nitrogen-containing organic compound, and
the nitrogen-containing organic compound is a nitrogen-containing heterocyclic compound.

2. The lithium-sulfur battery positive electrode of claim 1, wherein
the nitrogen-containing heterocyclic compound is a compound containing a pyridine cyclic skeleton.

3. The lithium-sulfur battery positive electrode of claim 1, wherein
in the sulfur layer, when content of the lithium-containing oxide is represented by A and content of the nitrogen-containing organic compound is represented by B, A≥B.

4. The lithium-sulfur battery positive electrode of claim 1, wherein
the lithium-containing oxide is composed of a compound which charges and discharges within a potential range of higher than 1.0 V (vs.Li/Li⁺) and less than 3.0 V (vs.Li/Li⁺).

5. The lithium-sulfur battery positive electrode of claim 4, wherein
the lithium-containing oxide is a lithium-titanium composite oxide.

6. The lithium-sulfur battery positive electrode of claim 1, wherein
the nitrogen-containing oxide is composed of a compound which charges and discharges within a potential range of higher than 1.0 V (vs.Li/Li⁺) and less than 3.0 V (vs.Li/Li⁺).

7. The lithium-sulfur battery positive electrode of claim 6, wherein
the nitrogen-containing organic compound is sulfurized polyacrylonitrile or a derivative thereof.

8. The lithium-sulfur battery positive electrode of claim 1, wherein
the sulfur layer further contains a carbon-based conductive additive.

9. The lithium-sulfur battery positive electrode of claim 8, wherein
the carbon-based conductive additive is porous carbon.

10. The lithium-sulfur battery positive electrode of claim 1, wherein
a total content of the lithium-containing oxide and the nitrogen-containing organic compound is 1% by weight or more and 20% by weight or less, based on a weight of the sulfur layer.

11. The lithium-sulfur battery positive electrode of claim 1, wherein
the lithium-sulfur battery positive electrode further includes a ceramic layer laminated on the sulfur layer, and the ceramic layer contains ceramic powder as a main component.

12. The lithium-sulfur battery positive electrode of claim 11, wherein
the ceramic powder is composed of titanium oxide or titanium-based composite oxide.

13. The lithium-sulfur battery positive electrode of claim 11, wherein
the ceramic layer further contains a nitrogen-containing heterocyclic compound.

14. A lithium-sulfur battery, comprising:
the lithium-sulfur battery positive electrode of claim 1;
a negative electrode capable of storing and releasing lithium ions; and
a separator impregnated with a nonaqueous electrolyte solution.

15. The lithium-sulfur battery of claim 14, wherein
the nonaqueous electrolyte solution contains an electrolyte composed of lithium salt, and a nonaqueous solvent, and
the nonaqueous solvent is a mixture of 1,3-dioxolane and dimethoxyethane.

16. The lithium-sulfur battery of claim 14, wherein
the nonaqueous electrolyte solution further contains lithium nitrate as a sub-electrolyte different from a main electrolyte which is a main component of the electrolyte.

17. A charging/discharging method of the lithium-sulfur battery of claim 14, the method comprising:
discharging is performed by setting a lower limit of a discharge voltage to 1.0 V (vs.Li/Li⁺) or more and 1.5 V (vs.Li/Li⁺) or less.

18. A charging/discharging method of the lithium-sulfur battery of claim 15, the method comprising:
discharging is performed by setting a lower limit of a discharge voltage to 1.0 V (vs.Li/Li⁺) or more and 1.5 V (vs.Li/Li⁺) or less.

19. A charging/discharging method of the lithium-sulfur battery of claim 16, the method comprising:
discharging is performed by setting a lower limit of a discharge voltage to 1.0 V (vs.Li/Li⁺) or more and 1.5 V (vs.Li/Li⁺) or less.
